(19) United States
(12) Patent Application Publication
(10) Pub. No.: US 2013/0239568 A1
(43) Pub. Date: Sep. 19, 2013

(54) Turbo Assist

(71) Applicants: Venkateshwaran Krishnan, Seal Beach, CA (US); Herman Artinian, Huntington Beach, CA (US); Tony Maffeo, Yorba Linda, CA (US); Keiichi Shiraishi, Nagasaki-City (JP)

(72) Inventors: Venkateshwaran Krishnan, Seal Beach, CA (US); Herman Artinian, Huntington Beach, CA (US); Tony Maffeo, Yorba Linda, CA (US); Keiichi Shiraishi, Nagasaki-City (JP)

(73) Assignee: Calnetix Technologies, LLC

(21) Appl. No.: 13/544,372

(22) Filed: Jul. 9, 2012

Related U.S. Application Data
(60) Provisional application No. 61/611,809, filed on Mar. 16, 2012.

(51) Int. Cl. F02B 37/10

(52) U.S. Cl. 60/608

(57) ABSTRACT

An aspect encompasses an engine system wherein a turbocharger system is coupled to an internal combustion engine to receive exhaust from the engine and to provide compressed air for combustion to the engine. The turbocharger system is driven to generate the compressed air by the exhaust from the engine. An electric machine is coupled to the rotating assembly of the turbocharger to assist generating compressed air and/or generate electricity from excess exhaust.

### CROSS-REFERENCE TO RELATED APPLICATION

This application claims the benefit under 35 U.S.C. §119(e) of U.S. Patent Application No. 61/611,809, entitled “Turbo Assist,” filed Mar. 16, 2012, which is incorporated herein by reference in its entirety.

### TECHNICAL FIELD

The present disclosure pertains to electric machines and turbochargers, and more particularly, to electric machines for operating in connection with turbochargers on internal combustion engines.

### BACKGROUND

A turbocharger or exhaust driven supercharger is a device, driven at least partially off the combustion exhaust of an internal combustion engine, that boosts the pressure and throughput of combustion air into the engine. The turbocharger has a compressor, typically a centrifugal compressor, for compressing the combustion air. The compressor resides on a common shaft with a turbine, typically a radial or axial turbine, for receiving the combustion exhaust and driving the compressor via the common shaft. The compressor, turbine and shaft define the rotating assembly of the turbocharger. FIG. 1 shows a typical turbocharged engine arrangement having a reciprocating internal combustion engine 12 with an exhaust manifold 14 and a turbocharger 16 coupled to receive exhaust from the manifold 14. The exhaust passes through the turbine of the turbocharger 16 and out an exhaust conduit 18. A wastegate valve 20 upstream of the turbocharger 16 can be selectively operated (e.g., by an engine control unit, ECU) to partially bypass the turbocharger 16, directing some of the exhaust directly into the exhaust conduit 18, thereby controlling the amount of exhaust going to the turbocharger. The exhaust that passes through the turbine of the turbocharger 16 drives the compressor to compress ambient air received at the turbocharger 16 and output the compressed air through an intake conduit 22 into the intake of the engine 12. The compressed air and fuel are combusted in the engine 12 to produce kinetic energy, typically in the form of rotating movement of an output shaft.

### DESCRIPTION OF DRAWINGS

FIG. 1 is a schematic flow diagram of a prior art internal combustion engine system having a turbocharger.

FIG. 2A is a schematic illustration of a side cross-sectional view of an example electric machine connected to a compressor and turbine.

FIG. 2B is a schematic illustration of a side cross-sectional view of another example electric machine connected to a compressor and turbine.

FIG. 3A is a graphical comparison of performance characteristics for a compressor with and without motor assistance.

FIG. 3B is another graphical comparison of performance characteristics of a compressor with and without motor assistance.

Like reference symbols in the various drawings indicate like elements.

### DETAILED DESCRIPTION

A turbocharger system on an engine can include an electric machine coupled to the rotating assembly of the turbocharger. The electric machine can assist driving the compressor to create higher supercharging pressure for engine operation, without having to rely on a supply of exhaust from the engine. The electric machine can also be used to recover energy from the engine, output by the engine in the form of excess exhaust. The energy recovered by the electric machine can be stored and used in powering the electric machine and/or can supplement other systems, including supplementing power to a power distribution grid. Other uses than those identified above for this power can be envisioned based on the specific application of the engine.

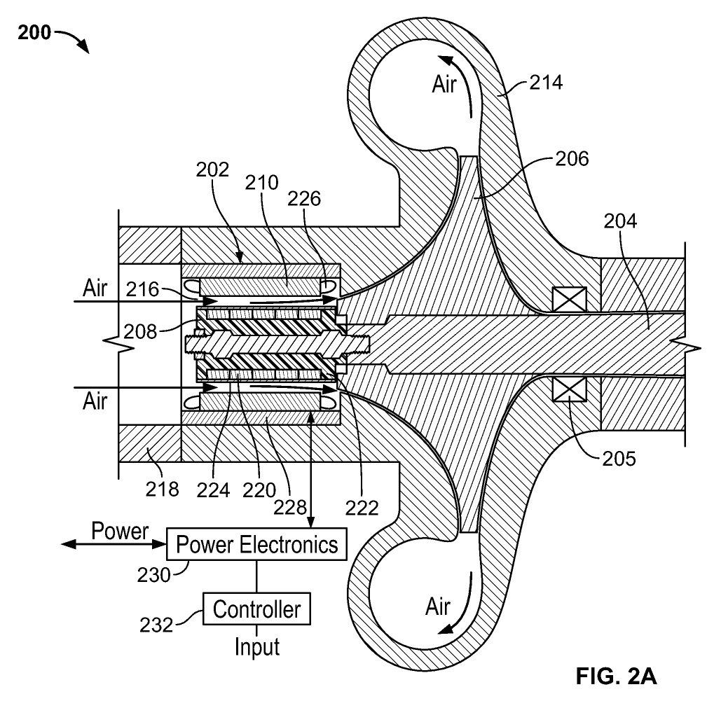

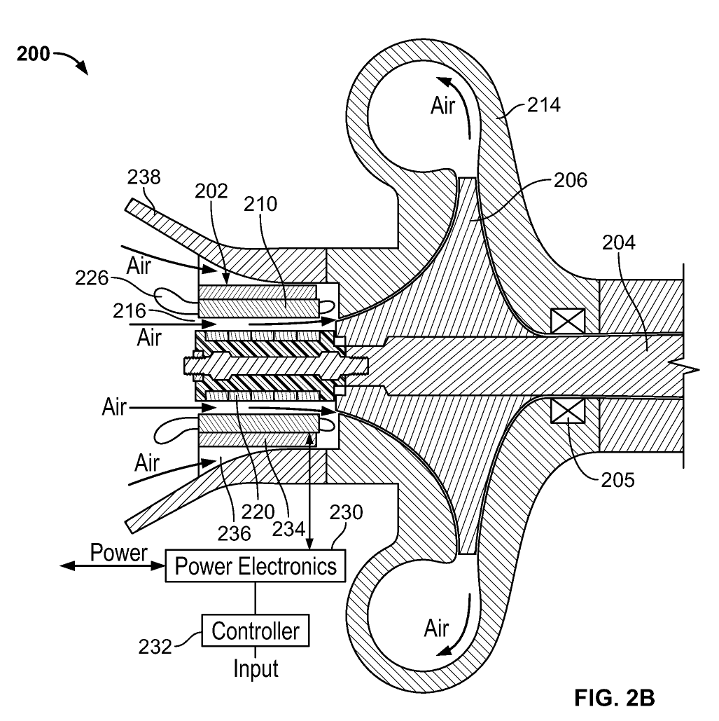

FIG. 2A is a schematic illustration of a side cross-sectional view of an example turbocharger system 200 with an electric machine 202. The electric machine 202 is coupled to the shaft 204 that carries the compressor 206 and the turbine (not shown) to rotate within a housing assembly 214. The shaft 204 is supported by one or more bearings 205 intermediate the compressor 206 and turbine. The housing assembly 214 has a compressor inlet 216 that couples to an air intake portion 218 of the engine. The electric machine 202 resides in the compressor inlet 216 within the housing assembly 214 (as shown in FIG. 2A) or in a separate housing attached to the housing assembly 214 (not shown).

The electric machine 202 includes a rotor 208 and a stator 210. The rotor 208 is configured to rotate within the stator 210, as described in more detail below. In certain instances, the electric machine 202 is a permanent magnet, synchronous, multiphase alternating current (A/C) motor/generator, where the magnetic field of the rotor 208 is generated entirely or in part by one or more permanent magnets. To this end, in FIG. 2A, the rotor 208 is shown with a plurality of permanent magnets 220 rigidly affixed to a cylindrical rotor shaft 222 using a non-magnetic sleeve 224. The rotor 208 is coupled to the shaft 204 so that rotation of the rotor 208 causes rotation of the compressor 206 and vice versa. In certain instances, the rotor 208 is directly coupled to the shaft 204 with no intermediate components (e.g., no couplings, gearbox, clutches, coupling and/or other components) or only rigid intermediate components. FIG. 2A shows a bolt-on arrangement with a bolt that extends through the rotor 208, and threadingly engages the shaft 204, clamping the rotor 208 abutting an end of the shaft 204. In other instances, the rotor 208 can be coupled to the shaft 204 using clutches, a gearbox with fixed or multiple gear ratios, a flexible or rigid coupling and/or in another manner. In certain instances, the manner of coupling the rotor 208 to the shaft 204 is configured to be selectively engaged or disengaged, for example, to enable the rotor 208 to be disengaged when not needed or desired. FIG. 2A shows the rotor 208 cantilevered off the end of the shaft 204, and no additional bearings (beyond the bearings 205) are needed to support the rotor 208. In other instances, additional bearings may be provided, for example, at the end of the rotor 208 opposite the coupling to the shaft 204. Such additional bearings can be mechanical bearings and/or magnetic bearings.

The stator 210 includes a winding 226 that can carry electrical current and either generate an electromagnetic field to drive the rotor 208 to rotate or, when the rotor 208 is rotated by the shaft 204, receive an induced current (i.e., generate electrical power). The stator 210 is contained (at least partially, or as shown in FIG. 2A, wholly) in an electric machine housing 228. In certain instances, the housing 228 includes cooling passages that receive a flow of a cooling fluid, thus enabling the housing 228 to operate as a cooling jacket to the remainder of the motor generator 202.

Although described herein as a permanent magnet AC electric machine 202, the electric machine 202 can take other forms, AC or DC, with or without permanent magnets, and/or other variations.

The electric machine 202 is electrically coupled to a power electronics module 230. In certain instances, the power electronics module 230, as will be discussed in more detail below, is bidirectional and conditions the electrical power to and from the electric machine 202 to specified parameters (e.g., specified voltage and/or frequency). In other instances, the power electronics module 230 is unidirectional. To enable driving the electric machine 202, the power electronics module 230 can include a variable frequency drive. The power electronics module 230 is coupled to a controller 232 that operates in controlling the electric machine 202 and/or the power electronics 230. For example, the controller 232 can control the power electronics module 230 to control the rate at which the electric machine 202 rotates when operating as a motor, as well as change the electric machine 202 between motoring and generating. The controller 232 can be separate from the engine's engine control unit (ECU) and communicate with the ECU and/or the controller 232 can be integrated with the engine's ECU.

The electric machine 202 is carried in the turbocharger system housing assembly 214. In certain instances, as shown in FIG. 2A, the housing assembly 214 can contact and seal around the perimeter of the electric machine housing 228. Such contact facilitates conductive heat transfer between the electric machine 202 and the housing assembly 214 for cooling the electric machine 202. Additionally, if sealed, all airflow en route to the compressor 206 (designated by the arrows labeled “Air”) must pass through the electric machine 202, thus cooling the electric machine 202. In certain instances, air can flow through an air gap between the rotor 208 and stator 210, through passages in the stator 210 itself and/or through other passages through the electric machine 202. In other instances, a gap and/or passages can be provided around the exterior of the electric machine 202 so that air en route to the compressor 206 flows around and cools the exterior of the electric machine 202. Suction created by operation of the compressor 206 can aid in drawing air through and/or around the electric machine 202. In certain instances, the conductive and/or convective cooling described above is enough to omit additional cooling mechanisms, including externally sourced coolant flow through the electric machine housing 228.

Although shown in FIG. 2A as being substantially cylindrical, the electric machine 202 can conform to the curvature of a bell-shaped intake housing 238 into the compressor 206. For example, while the rotor 208 and stator 210 of the electric machine 202 remain substantially cylindrical, all or a portion of the outer diameter of electric machine outer housing 234 can correspond to and match, entirely or substantially, the inner diameter of the bell-shaped intake 238. Further, the housing 234 can include azimuthally spaced apart fins 236 that extend into contact with the interior surface of the bell-shaped intake 238 and the stator 210. Like the housing 228 of FIG. 2A, the fins 236 conductively heat transfer between the electric machine 202 and the exterior parts of the turbocharger (here, the bell-shaped intake 238), but also allow air to pass over the exterior of the stator 210 to the compressor 206 in the spaces between the fins 236 for additional convective cooling. In certain instances, the upstream end turns of the windings 226 can be shaped to mimic the curvature of the bell-shaped intake 238, having the same or a similar radius of curvature as the curvature of the intake 238. Such a curved shape end turns lessens the resistance to air flowing through the electric machine 202 over end turns that are not so curved.

The turbine of the turbocharger system 200 is coupled to receive combustion exhaust from combustion of fuel and air within the internal combustion engine via the engine's exhaust manifold. The engine can be a reciprocating internal combustion engine powered by heavy fuel oil, diesel, gasoline, natural gas and/or other fuel. In other instances, the engine could be another type of engine. For example, the engine could be a non-piston type engine, such as a Wankel rotary engine and/or other type of engine. The exhaust output from the engine passes through the turbine and drives the turbine to rotate, and in turn, rotate the compressor 206. As the compressor 206 rotates, it draws in air from the intake portion 218, compresses the air and outputs that compressed air to the engine for use in combusting fuel. The amount of exhaust available to drive the turbine and, thus the compressor 206, is dependent on engine operation. For example, the engine produces more exhaust under high load and/or at high operational speeds, and less exhaust under low load and/or at low operational speeds. Greater amounts of exhaust typically enable driving the compressor 206 to rotate more quickly. The flow and pressure of air output by the compressor 206, in turn, is dependent on the speed at which the compressor 206 rotates and the efficiency of the compressor at the rotational speed. Therefore, the flow and pressure output from the compressor 206, to the extent the compressor 206 is driven by the turbine, is tied to the engine operating conditions.

At some engine operating conditions, the engine does not produce enough exhaust to rotate the compressor 206 at a rate that produces a desired or specified flow and pressure of air to the engine and/or a desired or specified compressor efficiency. The electric machine 202 can be used to electro assist operation of the turbocharger, i.e., drive the electric machine 202 to assist the turbine in rotating the shaft 204 and/or brake the shaft 204 with the electric machine 202 to achieve the desired or specified engine operating efficiency and/or desired or specified compressor efficiency. For example, at a given engine operating condition, the available exhaust alone may not be enough to rotate the compressor 206 fast enough to achieve a desired or specified (e.g., maximum) engine efficiency. The electric machine 202 may be powered to assist the turbine in rotating the compressor 206 faster, and fast enough to achieve the desired or specified engine efficiency at the given operating condition. In another example, at a given engine operating condition, the available exhaust alone may operate the compressor 206 in stall. Power can be supplied to the electric machine 202 or the electric machine 202 operated to generate power to brake the rotating compressor 206 to a rotational rate that produces stable pressure generation. In yet another example, power can be supplied to the electric machine 202 to assist or brake rotation of the compressor 206 to maintain the compressor at a desired or specified (e.g., maximum) compressor efficiency over different exhaust production of the engine and/or different ambient conditions. By assisting or braking the rotation of the compressor 206 using the electric machine 202, the engine and/or the compressor 206 can be maintained at desired or specified operational efficiencies regardless of the exhaust produced by the engine and ambient conditions. In instances where an auxiliary blower is provided to supply additional compressed air to the engine (beyond what the turbocharger would normally), the electric machine 202 can operate the compressor 206 to supplement the operation of the auxiliary blower or can enable omitting the auxiliary blower.

Some engines with turbochargers are optimized to run for extended periods of time at a specified steady state engine operating conditions. When the engine operation departs from the specified, optimum steady state engine operating conditions, the efficiency of the engine operation drops and in some cases, drops substantially. Some examples of engines optimized to run for extended periods of time at specified steady state operating conditions include engines used for marine propulsion, engines used for generating power in rail applications, stationary engines such as used for running generators, pumps or compressors, and/or other engines. By assisting or braking the rotation of the compressor 206 using the electric machine 202, the amount of air supplied by the turbocharger system 200 can be adjusted based on engine requirements, rather than based on available exhaust for operating the turbine, to improve (and sometimes maximize) engine operating efficiency at operating conditions different from the specified, optimum steady state engine operating conditions. For example, in the context of a marine propulsion engine, the turbocharger system 200 described above would allow the vessel to cruise at differing speeds above and below the cruising speed associated with the specified, optimum steady state engine operating conditions while still maintaining a high engine operating efficiency. One measure of engine operating efficiency is fuel efficiency. Operating the turbocharger system 200 as described above can improve fuel efficiency of the engine operation across multiple operating conditions of the engine above and below the specified, optimum engine operating conditions. In improving fuel efficiency, emissions can also be decreased.

During transient operation, the exhaust to the turbocharger system 200 lags, in time, the engine loading and speed events that cause the engine to generate exhaust. This lag, together with a lag resulting from accelerating the inertial mass of the rotating assembly, delays the operation of the compressor 206 in generating a desired or specified flow and pressure of air to the engine. Power can be supplied to the electric machine 202 to assist in accelerating the compressor 206 and/or brake the compressor 206 more quickly and independently from the exhaust production to reduce lag.

At startup, power can be supplied to the electric machine 202 to turn the compressor 206 to supply compressed air to the engine to facilitate start-up, even though little or no exhaust is being produced. In instances where a supplemental start-up booster compressor is used to facilitate engine start-up, the electric machine 202 rotating the compressor 206 can supplement, and in some instances, supplant the supplemental start-up booster.

In certain instances, a controller 232 can include a control algorithm for controlling the turbocharger system 200 to supply air to the engine based on engine demands, for example, to achieve a desired or specified engine operation (e.g., maximum efficiency), regardless of the exhaust available to operate the turbocharger system 200. The controller 232 can include a number of inputs, including one or more engine operating parameters (e.g., engine speed, throttle position, engine load, compressor speed and/or other operating parameters). The control algorithm can cover start-up, transient operation and/or steady state operation. The controller 232 can be pre-programmed with a map of compressor 206 operation to engine operating condition and/or the controller 206 can adaptively derive the operation of the compressor 206 based on engine operating conditions. The controller 232 can be coupled to the power electronics 230 to operate the power electronics 230 in operating the electric machine 202.

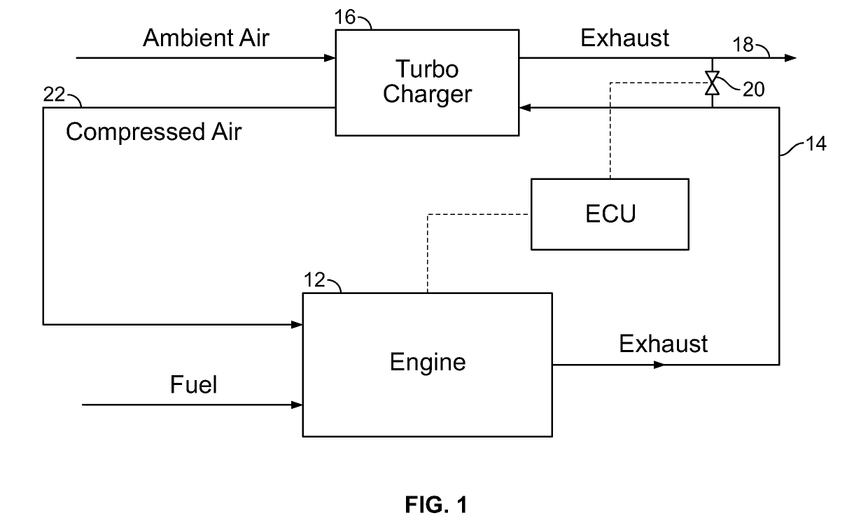

In certain instances, the electric machine 202 can be powered by excess exhaust to generate power. For example, at some engine operating conditions, typically high load and high speed, the amount of exhaust available to drive the compressor 206 is more than is needed to operate the engine at the operating conditions. As mentioned above, this excess exhaust is normally vented by a wastegate valve (e.g., wastegate valve 20 of FIG. 1). However, rather than venting the excess exhaust, the excess exhaust can be maintained passing through and powering the turbine to rotate the compressor 206. The electric machine 202 is operated as a generator to brake the compressor 206 and generate electrical power. In certain instances, the power can be provided to bidirectional power electronics 230 and conditioned for storage and later use in powering the electric machine 202. Alternately or additionally, the power can be used for powering other components of the engine and/or a larger system, and can be supplied to a power grid or stored. The power output by the electric machine 202 can be used to supplement or replace other generators (e.g., on-board generators of a vehicle, such as a ship or boat, rail car, airplane and/or road going vehicle). The electric power generated by the electric machine 202 may be of a certain phase, frequency, voltage and be AC or DC, depending on the configuration and operating speed of the electric machine 202. The power electronics 230 can reconfigure one or more of the phase, frequency, and/or voltage of the electric power to a desired or specified phase, frequency, and/or voltage, for example, to match the power carried on the grid or bus or other specified characteristics. In certain instances the power electronics 230 includes an inverter and/or rectifier for converting from AC to DC or DC to AC depending on the configuration of the electric machine 202 and the desired output from the power electronics 230. For example, the power electronics 230 may be used to output 3-phase 60 Hz AC power output at a voltage of about 400 VAC to about 480 VAC, preferably about 460 VAC. Other settings, including other phases, frequencies, and voltages, AC or DC are within the concepts described herein.

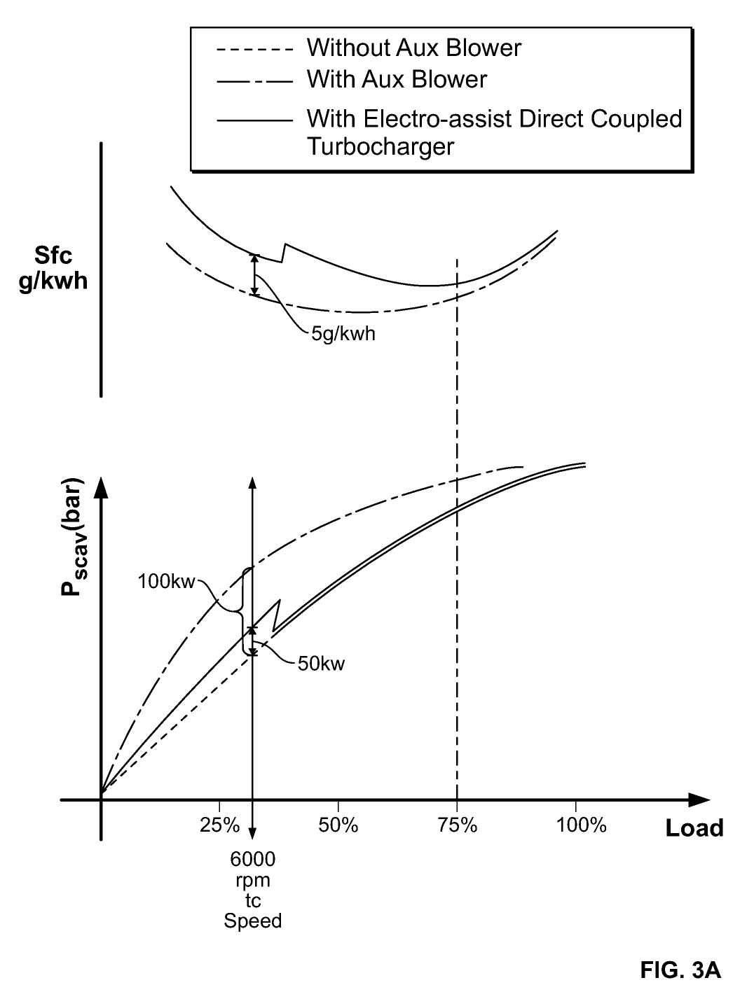

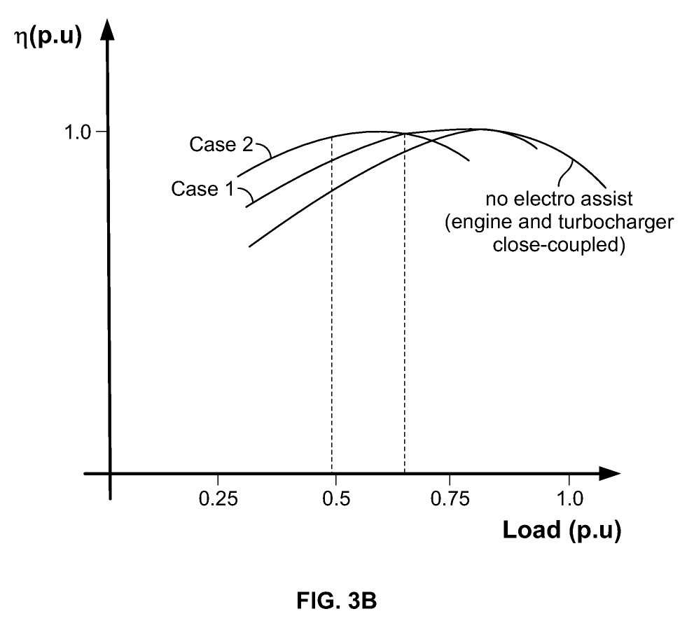

FIGS. 3A and 3B are graphical comparisons of example performance characteristics for a compressor with and without electric machine assistance. As can be seen from the graphs, the engine operation efficiency can be improved over the entire operating range. In the example, powering the electric machine to drive the compressor is able to improve efficiency at 0.6 load (Case 1) and at 0.45 load (Case 2) as compared to without the electro assist of the electric machine.

As discussed above, in certain aspects, the turbocharger system can be operated to decrease fuel consumption and emissions across multiple operating conditions of the engine above and below the engine's optimum engine operating conditions. For example, the engine can be operated at part load, yet with higher fuel efficiency and lower emissions that it would have with a conventional turbocharger.

In certain aspects, the turbocharger system can be controlled to control back pressure of the engine. For example, the turbocharger system can be operated to reduce back pressure of the engine. Reducing back pressure helps with a cleaner scavenge cycle in a two stroke engine.

In certain aspects, the turbocharger system can supplement or eliminsate the need for auxiliary blowers or compressors that supply air to the engine, including auxiliary blowers used to supplement turbocharger operation and/or start-up booster compressors used to facilitate engine start-up.

In certain aspects, the electric machine can be provided without any bearings, making it easier to incorporate an electric machine to an existing turbocharger design and making the system lower cost than if a bearing were provided in the electric machine. Furthermore, the electric machine efficiency can be higher because there are no bearing frictional losses.

In certain aspects, the electric machine enables rotating the rotating assembly of the turbocharger system so that it can be balanced without having to remove the turbocharger system from the engine. Further, rotating the rotating assembly when the engine is not in use can clean the compressor and/or turbine blades, and can pressurize the engine to clean deposits from inside the engine. Even during operation, the rotating speed of the turbocharger system can be controlled to promote cleaning the compressor and/or turbine blades. Also, motoring the rotating assembly can smooth out cyclical operating speeds that fatigue the compressor and turbine, and therefore, reduce fatigue stresses.

In certain aspects, the electric machine can be cooled without any active cooling, only by the intake air flowing through and/or around the electric machine and the conductive heat transfer with the housing of the turbocharger system. In certain aspects, additional liquid cooling can be provided in the housing of the electric machine.

A number of implementations have been described. Nevertheless, it will be understood that various modifications may be made. Accordingly, other implementations are within the scope of the following claims.

What is claimed is:

1. A turbocharger system for operating on an engine, comprising:
a turbine configured to rotate in response to engine exhaust;
a compressor coupled to the turbine to rotate together with the turbine;
an electric machine comprising a stator and a rotor, the rotor supported to rotate in the stator and coupled to the compressor to rotate together with the compressor and turbine; and
a controller coupled to the electric machine configured to control the electric machine to control a rotational speed of the compressor in relation to operation of the engine.

2. The turbocharger system of claim 1, where the controller is configured to control the electric machine to drive the compressor when the compressor operating efficiency is below a specified operating efficiency.

3. The turbocharger system of claim 2, where the controller is configured to control the electric machine to brake the compressor when the compressor operating efficiency is below a specified operating efficiency.

4. The turbocharger system of claim 3, where the controller is configured to control the electric machine to drive the compressor when the engine is operating below a specified operating efficiency.

5. The turbocharger system of claim 3, where the controller is configured to control the electric machine to generate electricity to brake the compressor.

6. The turbocharger system of claim 1, where the controller is configured to control the electric machine to brake the compressor when the compressor operating efficiency is below a specified operating efficiency.

7. The turbocharger system of claim 1, where the controller is configured receive an input of an engine operating parameter indicative of engine operating efficiency; and
where the controller is configured to control the electric machine to drive the compressor when the engine is operating below a specified operating efficiency.

8. The turbocharger system of claim 1, where the controller is configured to receive an input of an engine operating parameter indicating an engine operating state; and
where the controller is configured to control the electric machine to brake the compressor when the turbine is driving the compressor at a rate that produces more compressed air than is needed for operating an engine at a specific operating state.

9. The turbocharger system of claim 1, where the controller is configured to receive an input of an engine operating parameter indicating an engine load; and
where the controller is configured to control the electric machine to adjust the speed of the compressor in a specified relationship to an engine load.

10. The turbocharger system of claim 1, where the turbine, compressor and rotor are directly affixed to a shaft and the rotor is supported in a cantilevered manner by a bearing proximate the compressor wheel.

11. The turbocharger system of claim 1, further comprising a power electronics configured to adjust an output frequency of electricity generated when the rotor is rotated by the turbine.

12. The turbocharger system of claim 1, comprising an inlet and where the electric machine is between the inlet and the compressor.

13. The turbocharger system of claim 12, further comprising an intake housing upstream of the compressor; and
a plurality of radially extending fins between the stator and the intake housing.

14. The turbocharger system of claim 1, where the rotor comprises permanent magnets.

15. A method of operating an engine, comprising:
receiving an input of an engine operating parameter; and
controlling a rotational speed of a compressor of a turbocharger with an electric machine in relation to operation of the engine.

16. The method of claim 15, where controlling a rotational speed of a compressor of a turbocharger with an electric machine in relation to operation of the engine comprises controlling the rotational speed of the compressor of the turbocharger with the electric machine to maintain a specified minimum compressor operating efficiency.

17. The method of claim 15, where controlling a rotational speed of a compressor of a turbocharger with an electric machine in relation to operation of the engine comprise controlling the rotational speed of the compressor of the turbocharger with the electric machine to maintain a specified engine operating efficiency.

18. The method of claim 15, where controlling a rotational speed of a compressor with an electric machine comprises driving the compressor and braking the compressor with the electric machine.

19. An engine system, comprising:
an engine;
a turbocharger comprising a turbine and compressor on a common shaft; and
a motor/generator comprising a rotor and stator, the rotor coupled to rotate with the shaft; and
a controller coupled to the motor/generator and configured to increase and decrease a rotational speed of the compressor in relation to operation of the engine.

20. The engine system of claim 19, where the controller is configured to increase and decrease the rotational speed of the compressor to maintain a specified engine operating efficiency.

21. The engine system of claim 19, where the engine comprises a marine propulsion engine.
